(19) United States
(12) Patent Application Publication
(10) Pub. No.: US 2013/0193182 A1
(43) Pub. Date: Aug. 1, 2013

(54) NAIL GUIDING DEVICE FOR COIL NAILER

(71) Applicant: YU-CHUAN CHIEN, Taichung City (TW)

(72) Inventor: YU-CHUAN CHIEN, Taichung City (TW)

(73) Assignee: SAMSON POWER TOOL CO., LTD., Taichung City (TW)

(21) Appl. No.: 13/364,274

(22) Filed: Feb. 1, 2012

(51) Int. Cl. B25C 1/00

(52) U.S. Cl. 227/136

(57) ABSTRACT

A guiding device for coil nailers includes a nose connected to a barrel with a longitudinal path defined in the barrel and an inlet is located at the mediate portion of the longitudinal path. A side plate extends from the barrel and a guiding slot is defined in the inside of the side plate. A hollow portion is defined in the inside of the lower end of the side plate and a cylinder is located on outside of the side plate. A stop plate extends from one side of the inlet of the barrel. The minimum distance from one side of the stop plate to the other side of the inlet is between two respective maximum diameters of the nail shank and the nail head. A rib extends from the inside of the stop plate and toward the axis of the path to maintain the nails to be straight.

### FIELD OF THE INVENTION

The present invention relates to a nail guiding device, and more particularly, to a nail guiding device for coil nails.

### BACKGROUND OF THE INVENTION

A conventional nose for a coil nailer is shown in FIGS. 1 to 3 and generally includes a nose base 1 and a cover 15 connected to one side of the nose base 1, a magazine 2 connected to a remote end of the nose base 1, a cover 25 connected to the magazine 2, and a nails 3 arranged in coil form.

The nose base 1 includes a barrel 10 with an longitudinal path 101 and an inlet 102 is defined at the mediate portion of the path 101. A side plate 11 extends from top of the barrel 10 and a guiding slot 1111 defined in an inside of the top of the side plate 11. A hollow portion 112 is defined in the inside of the lower end of the side plate 11. A cylinder 12 accommodates a piston (not shown) and a push rod 121 which has one end extending through the cylinder 12 and connected to a main push block 14 so that one side of the main push block 14 extends through the hollow portion 112 via the outside of the wing plate 11 and enters into the inside of the side plate 11. By this arrangement, the main push block 14 is moved back and forth along with the movement of the push rod.

The cover 15 is connected to the nose base 1 and includes a pin 151 and a sub push block 152.

The magazine 2 has one end connected to one side of the nose base 1 and the other end of the magazine 2 is connected to the body of the nailer (not shown). The magazine 2 includes a space 20 for accommodating nails 3 which are arranged in coil form.

The cover 25 has one end connected to the magazine 2.

When using the coil nailer, the nails 3 are installed in the space 20 between the magazine 2 and the cover 25, the heads 30 of the nails 3 are located in the guiding slot 111 and pulled into the path 101. Two respective shanks 31 of two nails 3 are engaged with the main push block 14. The cover 15 is then mounted to the magazine 1 to compete the ready-to-shoot status.

However, the inlet is an rectangular and straight opening which is located on one side of the path so that the size of the opening is larger than the diameter of the heads of the nails, and the inner diameter of the path is much larger than the size of the heads of the nails. Besides, the length of the path is longer than that of the nail and the manufacturing tolerance of the pin the cover, increase the gap between the nails and the path. Especially the tolerance between the cover and the nose base, and between the two adjacent nails is significant. Therefore, when the nails are moved to the path, the nails can be pulled to the position to be shot, but the wires connected between the nails are pulled to tilt the first nail in the path and the second nail located beside the inlet. Furthermore, the gap between the heads of the nails and the path is too big so that the nails swing and tilt when the wires are pulled. The nails then are shot at an angle relative to the object, or when the head of the nail shifts too much, the tip of the nail is ejected from the bottom of the inlet and toward the side plate to case tumbling or jamming.

Another drawback is that because the heads of the nails are located at the bottom of the strike member because the nails are inclined, when the nails are shot, the penetration force is reduced and there will be double mark on the object to be nailed, and which means the nail head and the strike member both make a mark on the object. This affects the outer appearance of the object.

The present invention intends to provide a guiding device for the nails of the coil nailer and the guiding device improves the shortcomings of the conventional guiding device.

### SUMMARY OF THE INVENTION

The present invention relates to a guiding device for coil nailers and comprises a nose, a cover connected to one side of the nose, a magazine connected to the distal end of the nose and a cover connected to the magazine. The nose has a barrel in which a longitudinal path is defined and an inlet is located at the mediate portion of the longitudinal path. A side plate extends from outside of the barrel and a guiding slot is defined in the inside of the top of the side plate. A hollow portion is defined in the inside of the lower end of the side plate and a cylinder is located on outside of the side plate. A stop plate extends from one side of the inlet of the barrel. The minimum distance from one side of the stop plate to the other side of the inlet is in a range between a maximum diameter of the shank of the nails and the maximum diameter of the head of the nails. A rib extends from the inside of the stop plate and toward the axis of the path so as to maintain the nails not to be tilted.

The primary object of the present invention is to provide a guiding device which maintains the nails to be straight when sent into the path. The heads of the nails are guided by the rib so that the nail is straightly nailed into the object such that the penetration force of the nails is sufficient without tumbling and jamming.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of the conventional coil nailer;

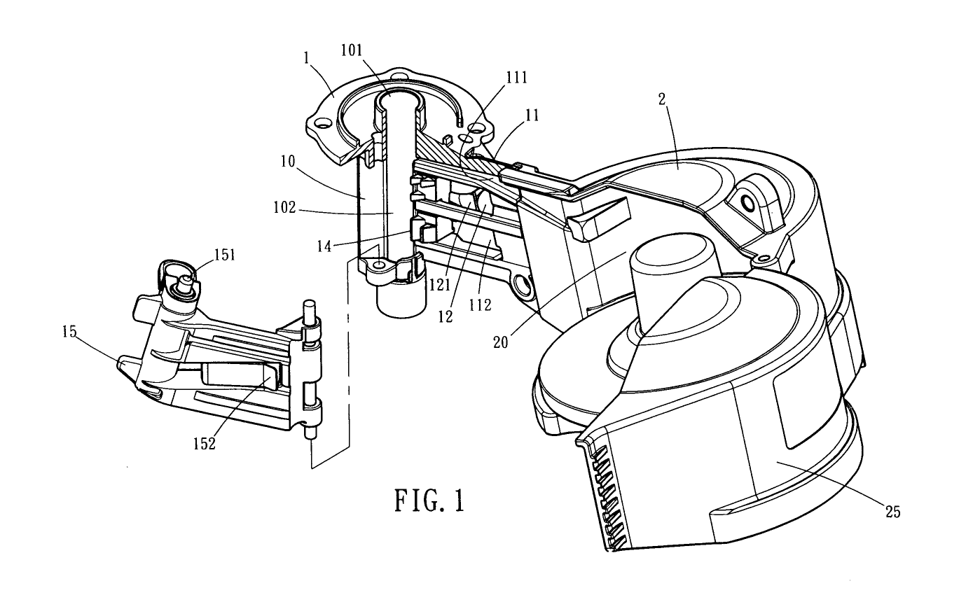

FIG. 2 is a cross sectional view of the conventional coil nailer;

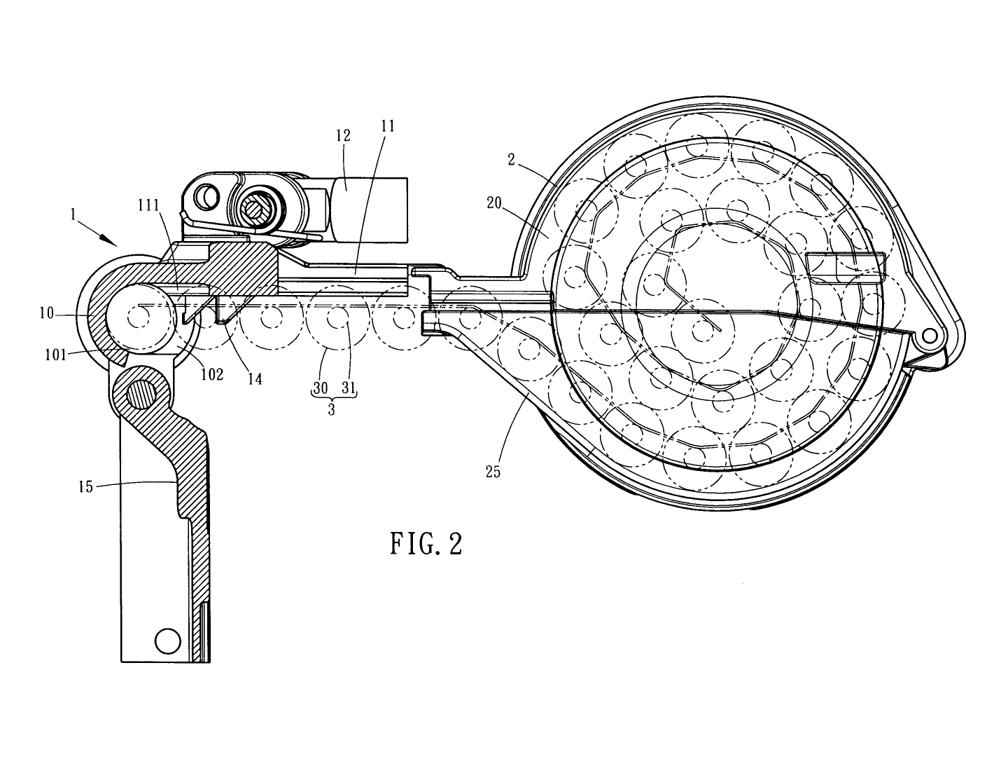

FIG. 3 is a cross sectional view to show the status after the conventional coil nailer is activated;

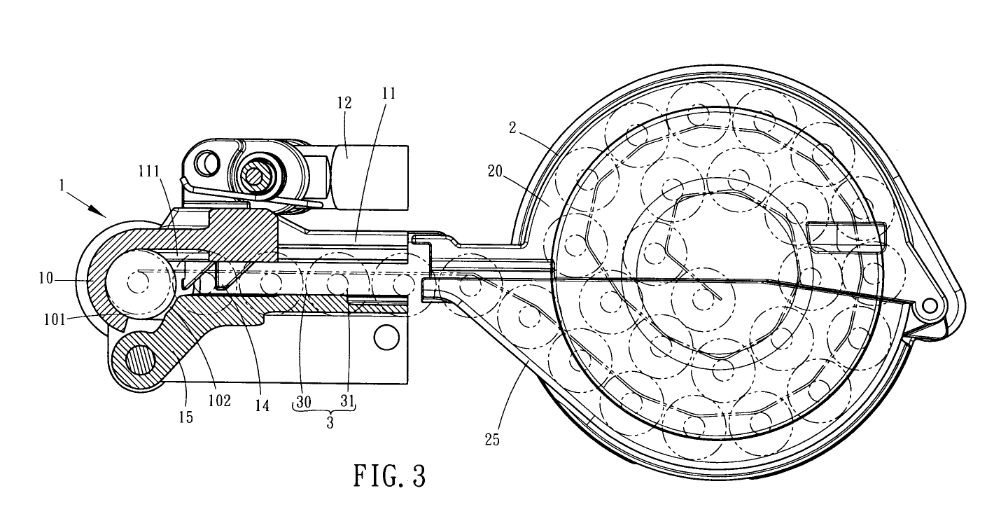

FIG. 4 is an exploded perspective view of the coil nailer of the present invention;

FIG. 5 shows the coil nailer of the present invention wherein the nails are reveled;

FIG. 6 is a side view of the coil nailer of the present invention;

FIG. 7 is a cross sectional view of the coil nailer of the present invention, wherein the cover is not yet closed;

FIG. 8 is a cross sectional view of the coil nailer of the present invention, wherein the cover is closed, and

FIG. 9 show the side view of the nose of the coil nailer of the present invention.

### DETAILED DESCRIPTION OF THE PREFERRED EMBODIMENT

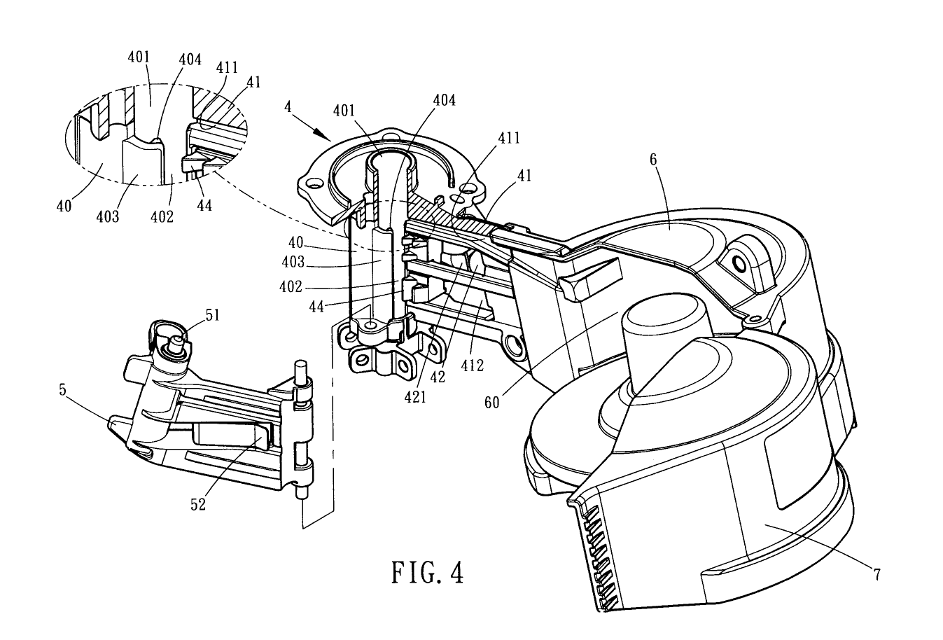

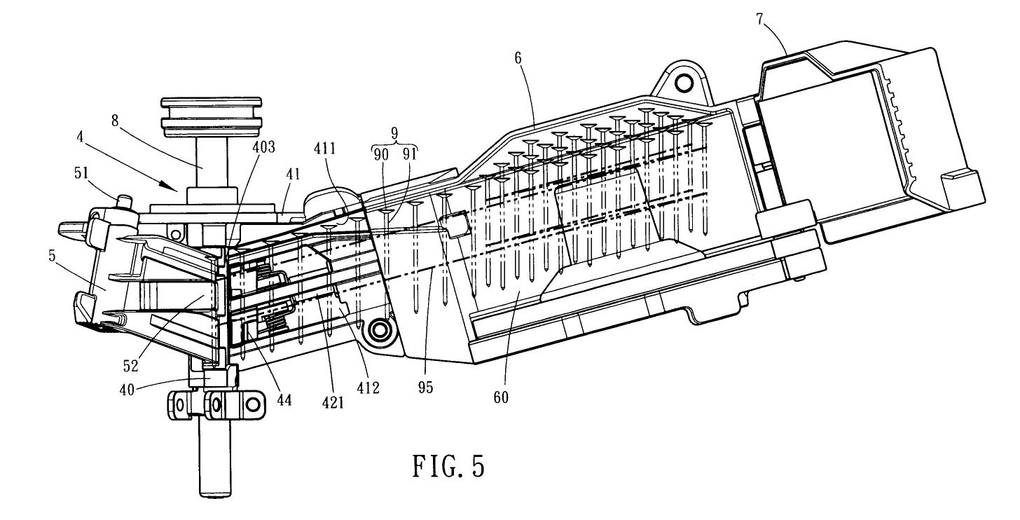

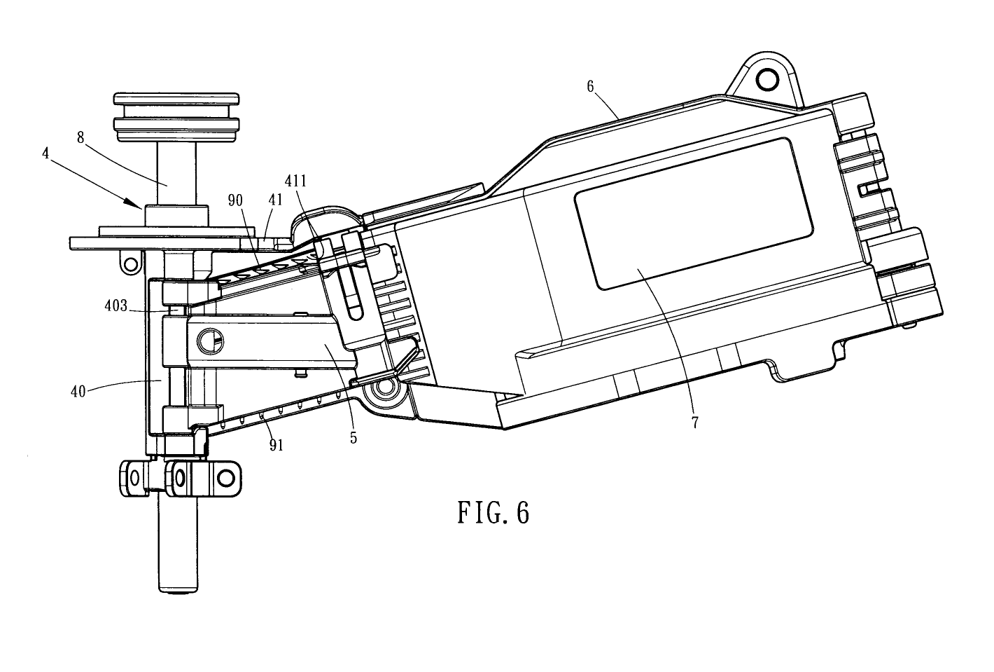

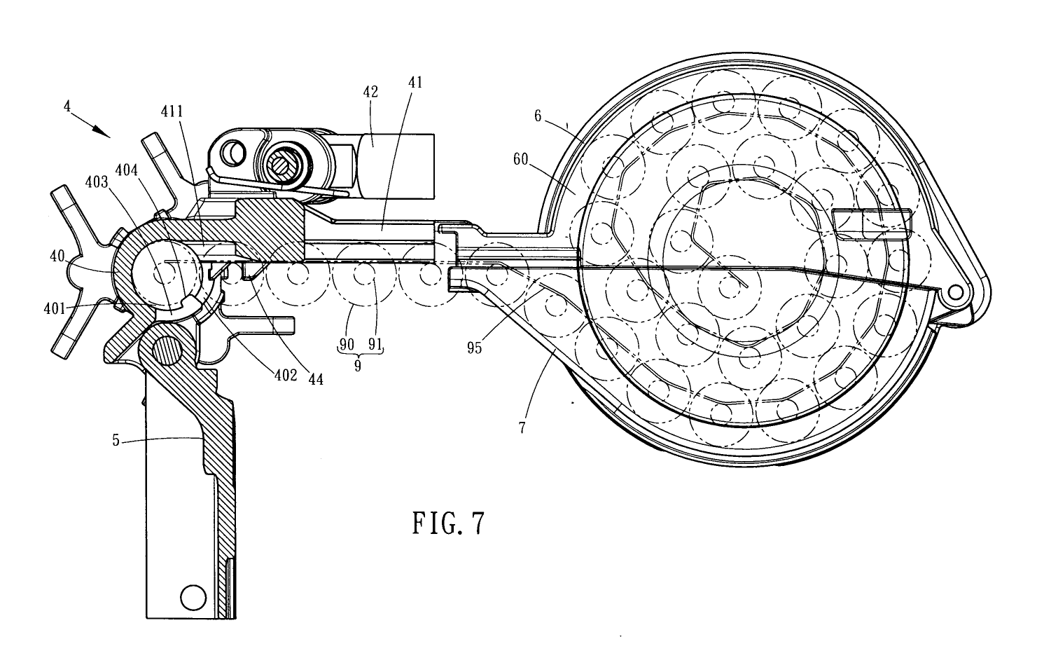

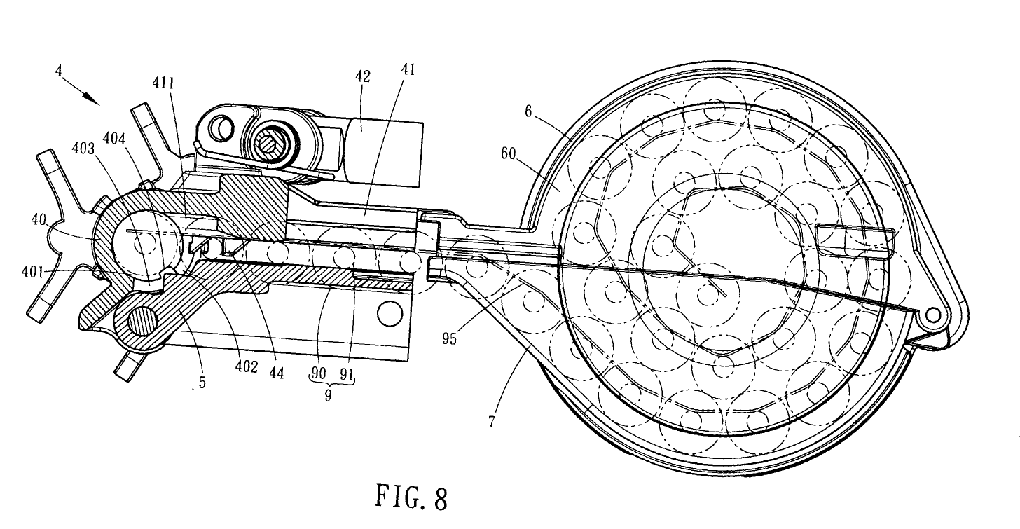

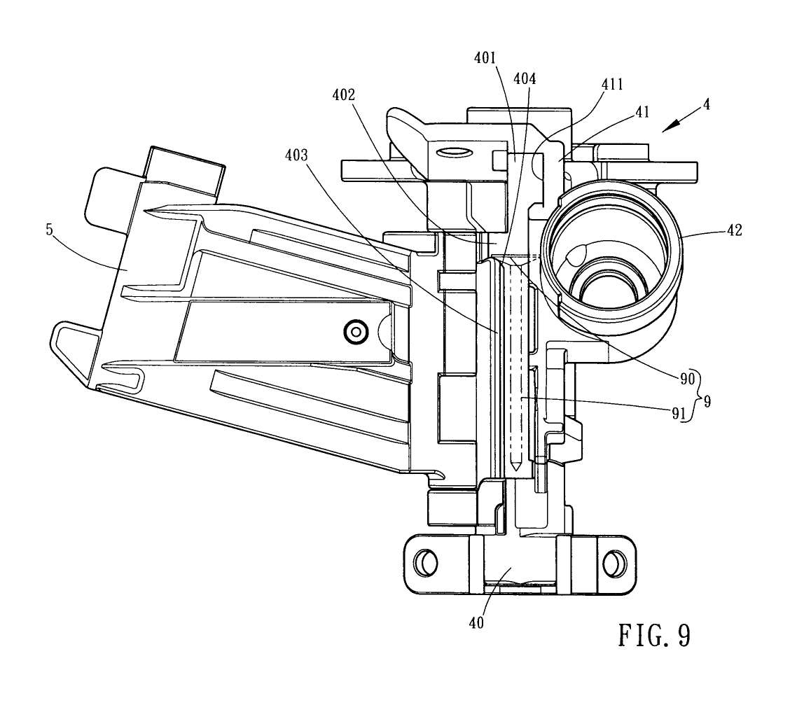

Referring to FIGS. 4 to 9, the guiding device for a coil nailer of the present invention comprises a nose 4, a cover 5 connected to one side of the nose 4, a magazine 6 connected to a distal end of the nose 4 and a magazine cap 7 connected to the magazine 6.

The nose 4 has a barrel 40 in which a longitudinal path 401 is defined, an inlet 402 located at the mediate portion of the longitudinal path 401, a side plate 41 extending from outside of the barrel 40, a guiding slot 411 defined in the inside of the top of the side plate 41, a hollow portion 412 defined in the inside of the lower end of the side plate 41, and a cylinder 42 located on outside of the side plate 41. The cylinder 42 receives a piston (not shown) therein and a push rod has its first end received in the cylinder 42 and the second end of the push rod extends through the cylinder 42 and is connected to a main push block 44. One end of the main push block 44 extends through the hollow portion 412 from the outside of the side plate 41 and enters into the inside of the side plate 41, so that the main push block 44 is moved back and forth along with movement of the push rod. A stop plate 403 extends from one side of the inlet 402 of the barrel 40 and toward the other side of the inlet 402. The rib 404 extends downward from the stop plate 403 and reaches to the outlet of the path 401, preferably, the stop plate 403 is a curved plate and the arc length of the top of the stop plate 403 is located within a range of 270 degrees wherein the barrel 40 is located at the center of the range. In other words, the minimum distance from one side of the stop plate 403 to the other side of the inlet 402 is in a range between the maximum diameter of a shank 91 of the nail 9 and the maximum diameter of a head 90 of the nail 9. A rib 404 extends from the inside of the stop plate 403 and toward the axis of the path 401. The rib 404 extends from the top of the stop plate 403 and extends downward to the outlet of the path 401 so that the nail is straightly nailed into the objects such that the penetration force of the nails is sufficient and the objects can be firmly nailed.

The cover 5 is connected to the nose 4 and has a pin 51 and a sub push block 52.

The magazine 6 has an end connected to one side of the nose 4 (the other side of the nose is connected to the body of the nailer and not shown in the drawings) and a space 60 is defined in the magazine 6. Nails 9 are arranged in coil form and received in the space 60.

The magazine cap 7 has one end connected to the magazine 6.

When in use, the nails 9 in coil form is received in the space 60 between the magazine 6 and the magazine cap 7, and the heads 90 of the nails 9 are pulled along the guiding slot 411 and the shank 91 of the first nail 9 is engaged with the main push block 44 (the first nail 9 is located on one side of the inlet 402). The cover 5 is then closed to the nose 4 so that the nails 9 located at the inside of the side plate 41 can be moved within the area between the side plate 41 and the cover 5. Because the stop plate 403 beside the inlet 402 is a curved plate and the minimum distance from one side of the stop plate 403 to the other side of the inlet 402 is in the range between the maximum diameter of the shank 91 of the nail 9 and the maximum diameter of the head 90 of the nail 9, and the rib 404 extends from the inside of the stop plate 403 and toward the axis of the path 401, when the trigger (not shown) and the safety rod (not shown) are pushed, the strike member 8 moves the first time while no nail is ejected, the piston in the cylinder 42 is activated and the push rod 421 is moved back and forth. The movement of the push rod 421 drives the main push block 44 backward and engages with the shank 91 of the second nail 9, while the shank 91 of the first nail 9 is restricted by the sub push block 52 on the cover 5 and the first nail 9 is stationary. The main push block 44 moves the second nail 9 forward to force the head 90 and the shank 91 of the first nail 9 are guided by the stop plate 403 so that the nail 9 is straightly sent into the path 401 via the inlet 402. When the trigger (not shown) and the safety rod (not shown) are pushed again, the strike member 8 strikes the head 90 of the first nail 9. The movement of the first nail 9 pulls the wires 95. Because there is a stop plate 403 at the side of the inlet 402 and the rib 404 extends toward the central axis of the path 401, the second nail 9 is pulled by the wires 95 and the head 90 of the second nail 9 is restricted by the stop plate 403 and the rib 404 so that the head 90 of the second nail 9 is not moved downward to prevent the head 90 of the second nail 9 located at the inlet 402 from being tilted. In the meanwhile, the first nail 9 is moved at straight pose. Because the rib 404 extends from the top of the stop plate 403 and reaches to the outlet of the path 401, so that the head 90 of the nail 9 is guided by the rib 404 after it is stricken and the nail 9 straightly penetrates the objects to be nailed. This increases the connection force between the objects to be nailed and improves the drawbacks of tumbling and jamming. The drawback of double marking is eliminated.

While we have shown and described the embodiment in accordance with the present invention, it should be clear to those skilled in the art that further embodiments may be made without departing from the scope of the present invention.

What is claimed is:

1. A guiding device for coil nailers, comprising:
a nose, a cover connected to one side of the nose, a magazine connected to a distal end of the nose and a magazine cap connected to the magazine;
the nose having a barrel in which a longitudinal path is defined, an inlet located at a mediate portion of the longitudinal path, a side plate extending from outside of the barrel, a guiding slot defined in an inside of a top of the side plate, a hollow portion defined in the inside of a lower end of the side plate, and a cylinder located on outside of the side plate, the cylinder adapted to receive a piston therein, a push rod having a first end received in the cylinder and a second end of the push rod extending through the cylinder and connected to a main push block, an end of the main push block extending through the hollow portion from the outside of the side plate and entering into an inside of the side plate, the main push block being moved back and forth along with movement of the push rod;
the cover having a pin and a sub push block;
the magazine having an end connected to a side of the nose and a space defined in the magazine, nails arranged in coil form being received in the space;
the magazine cap having an end connected to the magazine;
wherein a stop plate extends from one side of the inlet of the barrel and toward the other side of the inlet, a minimum distance from a side of the stop plate to the other side of the inlet is in a range between a maximum diameter of a shank of the nail and a maximum diameter of a head of the nail, a rib extending from an inside of the stop plate and toward the axis of the path so as to maintain the nails not to be tilted.

2. The guiding device as claimed in claim 1, wherein the rib extends downward from the stop plate and reaches to an outlet of the path.

3. The guiding device as claimed in claim 2, wherein the stop plate is a curved plate and an arc length of a top of the stop plate is located within a range of 270 degrees wherein the barrel is located at a center of the range.
